(19) United States
(12) Patent Application Publication
(10) Pub. No.: US 2023/0289629 A1
(43) Pub. Date: Sep. 14, 2023

(54) DATA-DRIVEN PREDICTIVE RECOMMENDATIONS

(71) Applicant: NCR Corporation, Atlanta, GA (US)

(72) Inventors: Itamar David Laserson, Givat Shmuel (IL); Shiran Abadi, Tel-Aviv (IL)

(21) Appl. No.: 17/711,164

(22) Filed: Apr. 1, 2022

Related U.S. Application Data
(63) Continuation-in-part of application No. 17/690,185, filed on Mar. 9, 2022.

(51) Int. Cl. G06N 5/04; G06N 5/02

(52) U.S. Cl. CPC G06N 5/04; G06N 5/022

(57) ABSTRACT

A prescriptive data model for stores of a retailer is maintained. The data model comprises clusters of benchmarks and benchmark values for successful stores and unsuccessful stores. A machine-learning model (MLM) is trained on the data model to predict Key Performance Indicator (KPI) values. An interface is provided that permits an end user to override a given current benchmark value with a changed value. The changed value along with unchanged current benchmark values are provided as input to the MLM and the MLM produces as output a set of current predicted KPI values. The set of current predicted KPI is rendered within the interface to the end user as a predicted impact the changed value will have on a given store or a given department of the given store.

### CROSS-REFERENCE TO RELATED APPLICATION

This application is a continuation-in part of U.S. Pat. Application No. 17/690,185, filed on Mar. 9, 2022; the application of which is incorporated herein in its entirety.

### BACKGROUND

A store’s success is measured by sales, margins, and labor costs. Every retail chain has successful stores, and ones that are lagging behind in terms of performance metrics. But there are hundreds of factors that influence a stores’ success. It is very difficult to isolate “quick wins” -opportunities for significant improvement.

In general, a store’s success is measured by three main components - sales, margins, and labor costs. Stores that achieve lower numbers in those metrics are considered unsuccessful. A retail chain could significantly increase its annual revenue by improving its lower performing stores. In many cases, there are quick wins that if only correctly identified would bring back substantial revenue with a small amount of effort.

But there are hundreds if not thousands of of factors that influence any given store’s success. Since an intricate set of properties affects a store’s revenue, it is hard to isolate factors that lead to one store being more successful than another.

Furthermore, even if the factors that correlate with sales, margins, and labor costs are identified and correlated with sales, margins, and labor costs. Retailers still need to be able to somehow predict how proposed changes in any combination of the correlated factors will result in improvements in their sales, margins, and labor costs. Otherwise changes in some of the correlated factors may not yield any substantial improvement in a given store’s sales, margins, and labor costs.

### SUMMARY

In various embodiments, system and a method for data-driven predictive recommendations are presented.

According to an aspect, a method for data-driven predictive recommendations is presented. A prescriptive data model is maintained for stores of a retailer. A trained machine-learning model (MLM) is trained on the prescriptive data model to produce as output predictive Key Performance Indicator (KPI) values. An interface is provided to an end user and a given store selection or a given department selection is received from the end user through the interface. Current benchmarks and current benchmark values for the given store of the given department are presented within the interface using the prescriptive data model. A user-supplied value that is associated with a change proposed by the end user is received through the interface for a given current benchmark value. The user-supplied value along with unchanged current benchmark values are provided to the MLM as input. A predicted KPI value for the given store or the given department is received as output from the MLM and the predicted KPI value is presented to the end user through the interface for the given store based on the user-supplied value and the unchanged current benchmark values.

### BRIEF DESCRIPTION OF THE DRAWINGS

FIG. 1 is a diagram of a system for data-driven predictive recommendations, according to an example embodiment.

FIG. 2 is a diagram of a method for data-driven predictive recommendations, according to an example embodiment.

FIG. 3 is a diagram of another method for data-driven predictive recommendations, according to an example embodiment.

### DETAILED DESCRIPTION

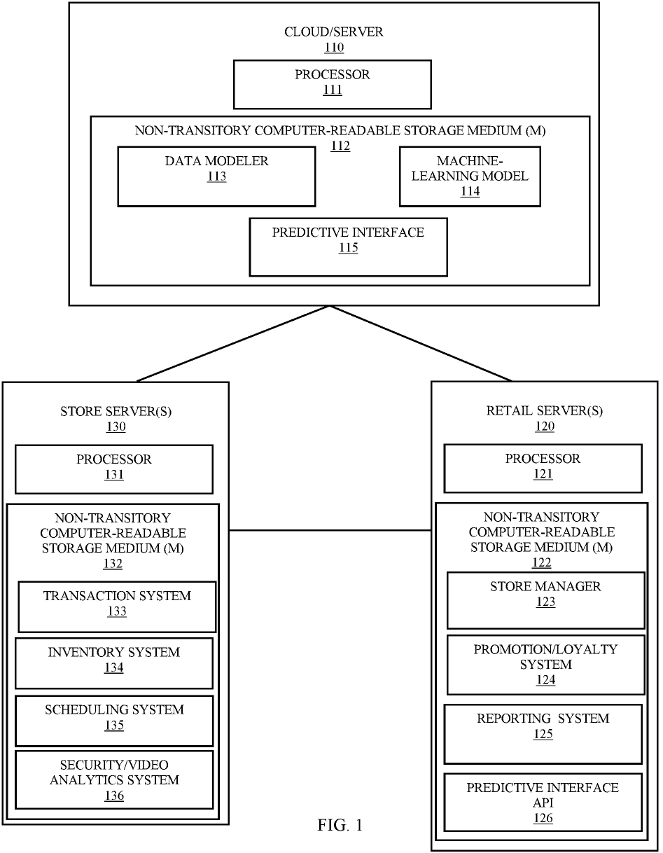

FIG. 1 is a diagram of a system 100 for data-driven predictive recommendations, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of data-driven predictive recommendations presented herein and below.

Existing retail solutions focus on measuring metrics. The solutions are mostly a descriptive analytics solution focusing on store operations and analytics that measure Key Performance Indicators (KPIs) such as revenue, profit margin, labor costs, shrink (loss), etc. The solutions rarely provide benchmarking that identify the cause at low performing metrics and even if they do, they do not isolate the problems that have the most impact nor do they propose any prescriptive recommendations. By and large, retailers rely on talented and clairvoyant store managers and department leaders to use their intuition for purposes of identifying problems and solving the problems. But talented store managers are not easy to find, and their analysis and intuition cannot compete with data-driven models provided herein and below. Moreover, a manager may be able to identify one factor that affects the store’s success, but it is not always possible to identify multiple factors with codependent effect.

System 100 deploys a variety of mathematical techniques and/or machine learning for developing an evolving a data model for successful stores and unsuccessful stores and identifying key differences between those that are successful and those that are unsuccessful. Store metrics are gathered, and measures calculated from the metrics are benchmarked. Each different type of benchmark is associated with a unique factor.

The benchmarked and calculated measures are arranged in a table data structure, such that each row represents a given factor (a given measure/benchmark), each column represents a given store, and each cell comprises that store’s recorded value for the given factor. The columns are sorted such that “successful stores” (those that exceed a threshold for predefined measures) are aggregated to the left in the table and such that “unsuccessful stores”) (those that fall below the threshold for predefined measures) are aggregated to the right in the table. An order of the rows is then optimized using a clustering algorithm that aggregates factors for which the values increase together in one group of stores and in contrast decrease together in the other group of stores. The clustered groups can be color coded such that low-level factors in a given store are green and high-level factors are red with varying shades of green to red depicted in the table for the clustered groups. The clusters of interest are those factors that are red in all the successful stores and green in the others and vice-versa. This permits identification of factors as the ones that make the difference between successful and unsuccessful stores. Next, the correlated factors in clusters of successful stores are labeled for their KPIs (such as sales, margin, and labor costs) and the correlated factors in the successful stores with labeled KPIs are used to train a regression-based machine-learning model (MLM) in order to derive a predictive function for the KPIs based on a change in any of the clustered factors for the successful stores, the values of the KPIs are a function of a change in any of the correlated and clustered factors associated with the successful stores. Once the MLM is trained, an interface is provided to the retailers allowing retailers to change specific values as hypotheticals for the correlated factors and receive in response the corresponding predictive values for the KPIs of any given store based on the proposed changes in the specific values.

The factors, by way of example only, comprise cashier proficiency levels for a given store based on transaction throughput calculations from transaction data, the number of voided items per cashier, a total number of transactions per a given time frame; planogram compliance levels for a given store based on video analytics of the items in the store compared to a planogram for the items of the store; total number of out-of-stock items for the given store based on item inventory reports; number of price overrides by cashiers of the given store (indicator of wrong pricing at the given store); average idle times for employees of the given store; Self-Service Terminal (SST) or Self-Checkout (SCO) occupancy levels based on a transaction volume at the SSTs versus overall transaction volume of the given store; promotion compliance levels based on the increase in sales for a given campaign versus sales without the campaign; average response time to counter nearby competitor offers; total value of fraud and theft within a given period of time; replenishment of items on the shelves based on expired items being removed from the shelves (spoilage rate); KPIs by departments; inefficient online transaction fulfillment based on an average fulfillment time for online orders; average checkout wait times (checkout queues) that impact shopper experience (based on visual analytics from video that measures customers wait times in checkout lanes for checkouts); inefficient labor scheduling based on scheduling data that schedules workers for less than optimal shifts determined by threshold shifts; suboptimal store assortment of products based on the item/product catalogue versus a threshold of different products; poor shelf or product labeling based on price lookups at checkout; etc.

System 100 obtains metrics in real time from a variety of store data sources, such as an inventory system 134, a transaction system 133, a loyalty system 124, promotion system 124, scheduling system 135, reporting system, security system 136, and video analytics system. The real time data is periodically processed for each of the factors/measures to calculate values (factor values, measure values, and/or benchmark values) for a given store during a reporting period. The values for each factor may be further compared against predefined thresholds and mapped to a scale associated with benchmarks (for example, high, medium, low, etc.) . Each factor/measure/benchmark label is populated to a table data structure as a row of the table, each unique store assigned a column in the table data structure, and each cell of the table represents a given store and a unique factor/benchmark/measure value. The values for each factor are colored with different shades between red (indicating a high value) and green (indicating a low value). Each store uniquely identified in the table is also labeled as being successful or unsuccessful based on its KPIs factors values (values for sales, margin, labor cost). The columns of the table are then sorted, such that the successful stores appear as columns to the left in the table and unsuccessful stores appear as columns to the right in the table.

Next, a clustering algorithm is processed similar to what is used with gene expression analysis for purposes of clustering the factors (rows within the table) that best distinguish between successful and unsuccessful stores. Eventually, the rows are ordered such that factors that hold high value for a group of stores (e.g., the successful ones) and low values for the other stores (e.g., the unsuccessful ones) are clustered together. Visually, this forms a heat map within the table with three main groups along the vertical axis: (1) with the factors that are red in all or most of the known successful stores and green in all or most of the unsuccessful stores, indicating conclusively high values for success and low values related to failure; (2) factors that are neither unique green nor red for a specific set of stores, indicating indistinctive effect or success or failure; and (3) factors that are green for the successful stores and red for the unsuccessful ones, indicating conclusively low values related to success and high values related to failure.

The result of the above-referenced processing is a data-drive prescriptive data model (table). High and low KPIs are then labeled in the table and the clusters or factor/benchmark values including the labeled KPls are used to train the MLM 114 for purposes of deriving a function, the KPI values are used as expected output from the MLM 114 when provided the clustered factor/benchmark values that are correlated to the KPls. Both the high KPIs for successful stores and the low KPIs for the unsuccessful stores can be provided during training of the MLM 114. Once trained, the correlated or clustered factor/benchmark values can be changed hypothetically or gathered in real time from the stores and fed to MLM 114 to receive a predicted KPI value based on the current metrics for the store and/or based on hypothetical factor/benchmark values. A predictive interface 115 allows retailers to interact with MLM 114, via an Application Programming Interface (API) 126), for determining current predictive KPIs for a given store based on its current metrics or for determining predictive KPIs based on proposed changes made for a given store to any of the clustered factor/benchmark value correlated with the KPIs.

It is within this context that system 100 is now discussed.

System 100 comprises a cloud/server 110, retail servers 120, and store servers 130.

Cloud/Server 100 comprises a processor 111 and a non-transitory computer-readable storage medium 112. Medium 112 comprises executable instructions for a data modeler 113, a MLM 114, and a predictive interface 115. Processor 111 obtains or is provided the executable instructions from medium 112 causing processor 111 to perform operations discussed herein and below with respect to 113-115.

Each retail server 120 comprises a processor 121 and a non-transitory computer-readable storage medium 122. Medium 112 comprises executable instructions for a store manager 123, a promotion/loyalty system 124, a reporting system 125, and a predictive interface API 126. Processor 121 obtains or is provided the executable instructions from medium 122 causing processor 121 to perform operations discussed herein and below with respect to 123-126.

Each store server 130 comprises a processor 131 and a non-transitory computer-readable storage medium 132. Medium 132 comprises executable instructions for a transaction system 133, an inventory system 134, a scheduling system 135, and a security/video analytics system 136.

During operation, data modeler 113 is configured to obtain metrics from a plurality of store servers 130 associated with a given retailer of a given retail server 120. The metrics are obtained from each of the store servers 130 and the corresponding retail server 120 from data produced by transaction system 133, inventory system 134, scheduling system 135, security/video analytics system 136, promotion/loyalty system 124, and reporting system 125. The of the metrics are mapped to factors/measures/benchmarks and the corresponding factor/measure/benchmark values are calculated. Rows of a table correspond to the factor/measures/benchmarks, columns of the table correspond to store identifiers, and each cell of the table comprises a given store’s corresponding benchmark value. Data modeler 113 then sorts columns of the stores into two groups, successful stores and unsuccessful store based on KPI values. The left side table comprises the successful stores and the right side of the table comprises the unsuccessful stores. Modeler 113 then runs a clustering algorithm on the cell values and the row (factor/measure/benchmark labels) to identify clusters of benchmarks that increase in cell values together in the successful stores and decrease together in unsuccessful stores. Each cluster of factors/benchmarks/measures show a correlation of varying degrees of strength to successful stores and unsuccessful stores.

Next, data modeler identifies one or more KPI from the benchmarks, such as sales, margin, and labor costs. The successful stores associated with KPI values above or below a threshold are used as expected output from regression-based MLM 114. So, if a given cluster having a strong degree of correlation to stores labeled successful, the KPI values for the cluster are retained as expected output from the MLM 114 during training. Input to the MLM comprises the cluster’s factor/benchmark values and the expected output is the actual KPI values that were in the cluster’s factor/benchmark values. In a similar way, training can be done on the unsuccessful stores. Modeler 113 trains MLM 114 over a variety of different periods of time for all stores of the retailer.

Once modeler 113 has obtained a desired level of accuracy from MLM 114 (using a threshold accuracy level) in correctly predicting KPI values when provided clustered benchmark values for stores, modeler 113 informs predictive interface 115 via a message that regression-based predictive MLM 114 is ready for use by a retailer associated with server 120 or by a store associated with server 130 of the retailer.

Interface 115 presents a user-facing interface to the retailer via an API 126. A store manager or any authorized employee of the retailer, such as a store manager of a given store, can access interface 115 via API 126. The API 126 may accessible via a browser through browser pages that can be accessed on a mobile device or a desktop through a connection to cloud/server 110. Additionally, API 126 may be accessible through a mobile application provided to employees of the retailer for download for purposes of connecting to cloud/server 110 and accessing API 126.

The user-facing interface of interface 115 presents a number of available user options to the end user (store manager or authorized employee of retailer). For example, a prediction of a given store’s KPI values can be provided automatically for a current period of time based on current metrics obtained for a given store by modeler 113 and passed to MLM 114 for current predicted KPI values based on the current metrics. A dashboard may be provided within the interface that shows each stores current predicted KPIs based on each stores current metrics for a given period of time, such that the end user does not have to request this option and it is available and updated automatically by interface 115 based on a current data model (table) being maintained in real time at predefined intervals of time by modeler 113. This dashboard may also be provided as a given store’s dynamic scorecard view option provided by interface 115 via API 126. The scorecard is dynamically updated within the user-facing interface as the table data structure is changed by modeler 113.

Another user-facing interface option allows for manual entry of % increases or decreases in any of the correlated factor/benchmark values from their current factor/benchmark values. For example, suppose a given store manager wants to increase SST adoption rate (self-checkout usage as compared to POS terminal transactions) at his/her store by 20% for the given period of time above its current SST adoption rate. Interface 115 receives the percentage increase for SST adoption rate, increases the current adoption rate from the current table by 20% and provides the changed adoption rate alone with the current clustered successful factors/benchmark values for the given store as input to MLM 114. MLM 114 process the benchmark values supplied as input and produces a labor cost reduction value that is 15% less than what the current labor costs are running by the end of the year. Interface 115 provides the 15% reduction prediction along with an indication based on current projected other KPI value returned from MLM 114 on whether this is labor cost reduction is enough to move the store to a successful store (assuming the store was unsuccessful to begin with) by the end of the year). The store manager may also see what changes occur when the SST adoption rate is increased by 40%; in this cases the reduction in labor costs may only be 20% as a prediction returned by MLM 114. User-facing interface of interface 115 may also allow the end user to change more than one of the benchmark values to see what happens with the store’s KPI values with multiple changes in the benchmark values. Any of the benchmark values can be changed with hypothetical changes by the end user to see what the predicted KPI values will be for any given store. Any “what if” scenario in the benchmark values can be provided by the end user within the user-facing interface using API 126 and interface 115 to the end user to find a workable benchmark that can be improved to move a given store’s KPI values into a determination that classifies that store as a successful store for the given period of time.

In an embodiment, the end user can create artificial benchmark values for a store or a proposed new store for purposes of determining whether the KPI values will be deemed a successful store or unsuccessful store at the end of a given period of time. The benchmark values are supplied to MLM 114 by interface 115 and the KPI values predicted returned and presented to the user through the user-facing interface using API 126.

The metrics (raw data collected) comprise a variety of data, by way of example only, such as and by way of example only, transaction identifiers for transactions, terminal type (Point-Of-Sale (POS) terminal, SST), transaction type (self-service, cashier-assisted, refund, purchase), transaction events (price overrides, promotions, voids, refunds, price lookups, transaction start time, transaction end time, etc.), transaction information (item code, item category, item price, item quantity, item weight, etc.), store identifier, terminal identifier, loyalty and promotion information (loyalty account, promotion campaign identifier, promotion redemption, promotion type, etc.), item inventory levels per item per store, planogram of items in each store, scheduling data per employee of a given store, scheduling data per day within a given period of a given store, etc., average wait times per customer per store within a given period, total amount by dollar value of theft or fraud per store within a given period, average online fulfillment times for online orders during a given period, average transaction time per item processed of a given transaction, average response time per store to competitor offers/campaigns within a given period, etc.

The metrics are passed to modeler 113 and modeler 113 calculates factor/measure/benchmark for each factor/measure/benchmark with each store of a given retailer for a given retail server 120. For example the metrics associated with a total number of transactions at a given store during the period for the POS terminal type is associated with cashiers performing transaction at that store. An average throughput for the transactions can be calculated as an average total number of items for the transactions over an average transaction time (calculated from the transaction start and end times) for the transactions. A total number of voids, overrides, and price lookups for the transaction can be obtained. The average throughput combined with the total number of voids, overrides, and price lookups can be mapped to a cashier proficiency for the given store. The SST occupancy benchmark can be calculated from the total number of SST terminal type transactions for the given period divided by the total transactions associated with both the total number of SST terminal type transactions and the total number of POS terminal type transactions. Modeler 113 calculates the metrics into values or measures associated with each factor of each store.

Modeler 113 continually (at predefined intervals of time) or in real time calculates the benchmark values from the collected real-time metrics of each store and updates the table data structure (data model) by sorting, organizing, clustering, and providing a degree of benchmark correlation for the successful and unsuccessful stores as discussed above. Modeler 113 also continuously schedules and processes training sessions with MLM 114 with the current data model for purposes of continuously training and improving the accuracy in the predictions of KPI values by the MLM 114.

Interface 115 uses the current data model to change actual benchmark values for any given store as provided by an end user and to obtain projected KPI values for that store based on one or more changed benchmark values (end user can identify changes with actual values or with percentage increases or decreases in the current values for a given period of time), which is then presented in the user-facing interface to the user through API 126. A current score card associated with the stores may be automatically provided by interface 115 though a dashboard KPI scorecard that comprises current projected KPI values for the stores based on the current benchmark values in the current data model.

In an embodiment, interface 115 may also present the current data table as a heat map to the end user through the user-facing interface, which is helpful to the end-user in selecting benchmark values (other than KPI values) since the cluster of benchmarks associated with a high-degree of correlation for successful stores can be changed over time by data modeler 113.

In an embodiment, each individual store can use model reporter 115 for purposes of optimizing individual departments by identifying factors contributing to successes and failures in a given department of a given store versus the same departments of other stores for the retailer. In this scenario, the columns remain the store identifiers and are labeled as successful or unsuccessful based on KPIs for the departments. The benchmark values calculated by modeler 113 are for benchmarks associated with a given department of the retailer (just metrics for the departments are processed to calculate the benchmark values housed in the cells of the data table). Here, a store manager can use interface 115 and MLM 114 for optimizing a given department of his/her store as compared to benchmark values associated with the same or related departments of other stores of the retailer by running scenarios in changes to correlated benchmark values for the department through MLM 114 and receiving predicted changes in the KPI values for the department back.

Thus, different levels of granularity are achievable for a retailer based on a store-to-store comparison or a department within a store to a same department and/or related departments within the stores comparison. Modeler 113 may dynamically and in real time derive the level of detail needed for a given level of granularity from the metrics and produce a given table (data model) when needed from metrics at department levels or at store levels.

System 100 continuously changes as success factors change, such that the data model provided via the table is dynamic, learning, and adaptive driven by current success factors of successful stores. System 100 provides a data-driven predictive recommendation on success factors that are needed to move an unsuccessful store to a successful store. System 100 is also continuously training MLM 114 for predicting KPI values from a given set of successful benchmark values associated with a current data model. System 100 allows an end user to provide substituted values (artificially) within a given period of time for any of the correlated successful benchmark values, which are then provided along with the unchanged current successful benchmark values as input to MLM 114 and predicted KPI values returned based on the hypothetical changes and unchanged current benchmark values. The end user can then see what changes made to successful correlated metrics will have on the projected KPI values at a department level of granularity and/or at a store level of granularity.

In an embodiment, the data associated with the metrics for the stores is housed on cloud/server 110 and accessible directly to modeler 113.

In an embodiment, the data associated with the metrics for the stores is housed on retail server 120 and obtained through an API by modeler 113 via store manager 123.

In an embodiment, some of the data associated with the metrics for the stores is housed on cloud/server 110 and other portions of the data associated with the metrics is housed on retail server 120.

In an embodiment, some or all of the benchmarks or measures/values for the factors are maintained by reporting system 125 and obtained via an API by modeler 113 as needed.

In an embodiment, system 100 is provided to a given retailer associated with retail server 120 as a Software-as-a-Service (SaaS).

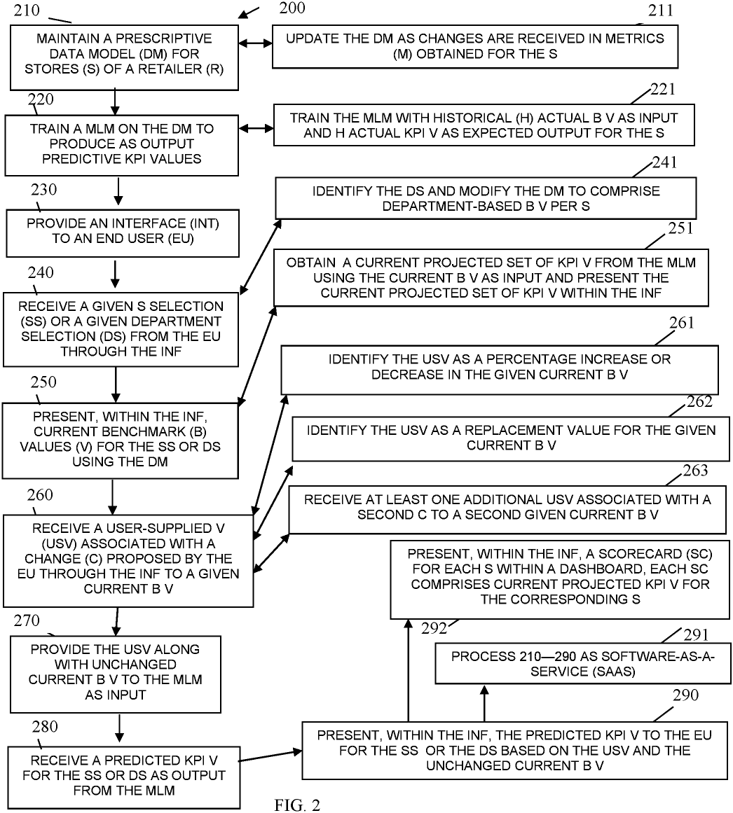

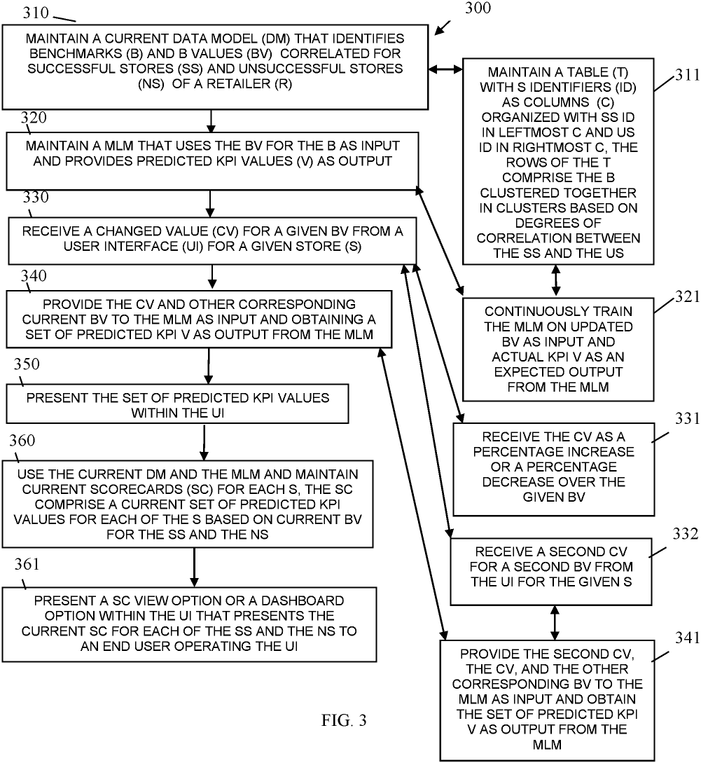

The above-referenced embodiments and other embodiments are now discussed with reference to FIGS. 2-3.

FIG. 2 is a diagram of a method 200 for data-driven predictive recommendations, according to an example embodiment. The software module(s) that implements the method 200 is referred to as a “KPI predictor.” The KPI predictor is implemented as executable instructions programmed and residing within memory and/or a non-transitory computer-readable (processor-readable) storage medium and executed by one or more processors of one or more devices. The processor(s) of the device(s) that executes the KPI predictor are specifically configured and programmed to process the KPI predictor. The KPI predictor has access to one or more network connections during its processing. The connections can be wired, wireless, or a combination of wired and wireless.

In an embodiment, the device that executes the KPI predictor is cloud 110. In an embodiment, the device that executes KPI predictor is server 110.

In an embodiment, the KPI predictor is all of, or some combination of data modeler 113, MLM 114, and/or predictive interface 115.

In an embodiment, the KPI predictor is provided to a retail server 120 and/or a store server 130 as a SaaS at a Business Service Level (BSL).

At 210, KPI predictor maintains a prescriptive data model for stores of a retailer.

In an embodiment, at 211, the KPI predictor updates the data model as changes are received in metrics obtained for the stores.

At 220, the KPI predictor trains a MLM 114 on the data model to produce as output predicted KPI values.

In an embodiment, at 221, the KPI predictor trains the MLM 114 with historical actual benchmark values as input and historical actual KPI values as expected output for the stores.

At 230, the KPI predictor provides an interface 115 to an end user.

At 240, the KPI predictor receives a given store selection or a given department selection from the end user through the interface 115.

In an embodiment, at 241, the KPI predictor identifies the given department selection and modifies the data model to comprise department-based benchmark values per store.

At 250, the KPI predictor presents, within the interface 115, current benchmark values for the given store selection or the given department selection using the data model.

In an embodiment, at 251, the KPI predictor obtains a current projected set of KPI values from the MLM 114 using the current benchmark values and presents the current projected set of KIP values within the interface 115 with the current benchmark values.

At 260, the KPI predictor receives a user-supplied value associated with a change proposed by the end user through the interface for a given current benchmark value. The user-supplied value representing a forecast of the end user to the given current benchmark value or an override to the given benchmark value.

In an embodiment, at 261, the KPI predictor identifies the user-supplied value as a percentage increase or decrease in the given current benchmark value.

In an embodiment, at 262, the KPI predictor identifies the user-supplied value as a replacement value for the given current benchmark value.

In an embodiment, at 263, the KPI predictor receives at least one additional user-supplied value associated with a second change to a second given current benchmark value. Here more than one benchmark value is being overridden and/or forecasted by the end user.

At 270, the KPI predictor provides the user-supplied value along with unchanged current benchmark values to the MLM 114 as input.

At 280, the KPI predictor receives a predicted KPI value for the given store selection or the given department selection as output from the MLM 114.

At 290, the KPI predictor presents, within the interface 115, the predicted KPI value to the end user for the given store selection or the given department selection based on the user-supplied value and the unchanged current benchmark values.

In an embodiment, at 291, the KPI predictor processes as a SaaS.

In an embodiment, at 292, the KPI predictor presents within the interface 115 a scorecard for each store or each department within a dashboard, each scorecard comprises current projected KPI values for the corresponding stores or corresponding departments.

FIG. 3 is a diagram of another method 300 for data-driven predictive recommendations, according to an example embodiment. The software module(s) that implements the method 300 is referred to as a “data-driven KPI predictor service.” The data-driven KPI predictor service is implemented as executable instructions programmed and residing within memory and/or a non-transitory computer-readable (processor-readable) storage medium and executed by one or more processors of one or more devices. The processor(s) of the device(s) that executes the data-driven KPI predictor service are specifically configured and programmed to process the data-driven KPI predictor service. The data-driven KPI predictor service has access to one or more network connections during its processing. The network connections can be wired, wireless, or a combination of wired and wireless.

In an embodiment, the device that executes the data-driven KPI predictor service is cloud 110. In an embodiment, the device that executes the data-driven KPI predictor service is server 110.

In an embodiment, the data-driven KPI predictor service is all of, or some combination of modeler 113, MLM 114, predictive interface 115, and/or method 200.

The data-driven KPI predictor service presents another and, in some ways, enhanced processing perspective from that which was discussed above with the method 200 of the FIG. 2.

In an embodiment, the data-driven KPI predictor service modeler is provided to a retail server 120 and/or a store server 130 as a SaaS and at BSL.

At 310, the data-driven KPI predictor service maintains a current data model that identifies benchmarks and benchmark values correlated for successful stores and unsuccessful stores of a retailer.

In an embodiment, at 311, the data-driven KPI predictor service maintains a table with store identifiers as columns and organized with successful store identifiers in leftmost columns and unsuccessful store identifiers in rightmost columns, the rows of the table clustered together based on degrees of correlation between the benchmarks and the benchmark values with the successful stores and the unsuccessful stores.

At 320, the data-driven KPI predictor service maintains a MLM 114 that uses the benchmark values for the benchmarks as input and provides predicted KPI values as output.

In an embodiment of 311 and 320, at 321, the data-driven KPI predictor service continuously trains the MLM 114 on updated benchmark values and actual KPI values as an expected output from the MLM 114.

At 330, the data-driven KPI predictor service receives a changed value for a given benchmark value from a user interface 115 for a given store.

In an embodiment, at 331, the data-driven KPI predictor service receives the changed value as a percentage increase or a percentage decrease over the given benchmark value.

In an embodiment, at 332, the data-driven KPI predictor service receives a second changed value for a second given benchmark value from the user interface 115 for the given store.

At 340, the data-driven KPI predictor service provides the changed value and other corresponding current benchmark values to the MLM 114 as input and obtains a set of predicted KPI values as output from the MLM 114.

In an embodiment of 332 and 340, at 341, the data-driven KPI predictor service provides the second changed value, the changed value and the other corresponding benchmark values as input to the MLM 114 and obtains the set of predicted KIP values as output from the MLM 114.

At 350, the data-driven KPI predictor service presents the set of predicted KPI values within the user interface.

In an embodiment, at 360, the data-driven KPI predictor service uses the current data model and the MLM 114 and maintains current scorecards for each of the stores. The scorecards comprise a current set of predicted KPI values for each of the stores based on current benchmark values for the successful stores and the unsuccessful stores.

In an embodiment of 360 and at 361, the data-driven KPI predictor service presents a scorecard view option or a dashboard option within the user interface 115 that presents the current score cards for each of the successful stores and the unsuccessful stores to an end user operating the user interface 115.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
maintaining a prescriptive data model for stores of a retailer;
training a machine-learning model (MLM) on the prescriptive data model to produce as output predictive Key Performance Indicator (KPI) values;
providing an interface to an end user;
receiving a given store selection or a given department selection from the end user through the interface;
presenting, within the interface, current benchmarks and current benchmark values for the given store selection of the given department selection using the prescriptive data model;
receiving a user-supplied value associated with a change proposed by the end user through the interface to a given current benchmark value;
providing the user-supplied value along with unchanged current benchmark values to the MLM as input;
receiving a predicted KPI value for the given store selection or the given department selection as output from the MLM; and
presenting, within the interface, the predicted KPI value to the end user for the given store selection of the given department selection based on the user-supplied value and the unchanged current benchmark values.

2. The method of claim 1 further comprising, processing the method as a Software-as-a-Service to a retail server associated with the retailer.

3. The method of claim 1 further comprising, presenting, within the interface, a scorecard for each of the stores within a dashboard, each scorecard comprises current projected KPI values for the corresponding store.

4. The method of claim 1, wherein maintaining further includes updating the prescriptive data model as changes are received in metrics obtained for the stores.

5. The method of claim 1, wherein training further includes training the MLM with input comprising historical actual benchmark values as input and historical actual KPI values as expected output.

6. The method of claim 1, wherein receiving the given store selection or the given department selection further includes identifying the given department selection and modifying the prescriptive data model to comprise department-based benchmark values per store.

7. The method of claim 1, wherein presenting the current benchmark values further includes obtaining a current projected set of KPI values from the MLM using the current benchmark values as input and presenting the current projected KPI values within the interface with the current benchmark values.

8. The method of claim 1, wherein receiving the user-supplied value further includes identifying the user-supplied value as a percentage increase or decrease in the given current benchmark value.

9. The method of claim 1, wherein receiving the user-supplied value further includes identifying the user-supplied value as a replacement value for the given current benchmark value.

10. The method of claim 1, wherein receiving the user-supplied value further includes receiving at least one additional user-supplied value associated with a second change to a second given current benchmark value.

11. A method, comprising:
maintaining a current data model that identifies benchmarks and benchmark values correlated with successful stores and unsuccessful stores of a retailer;
maintaining a machine-learning model that uses the benchmark values for the benchmarks as input and provides predicted Key Performance Indicator (KPI) values as output;
receiving a changed value for a given benchmark value from a user interface for a given store;
providing the changed value and other corresponding current benchmark values to the MLM as input and obtaining a set of predicted KPI values as output from the MLM; and
presenting the set of predicted KPI values within the user interface.

12. The method of claim 11, wherein maintaining the current data model comprises maintaining a table with store identifiers as columns organized and with successful store identifiers for the successful stores in leftmost columns of the table and with unsuccessful store identifiers for the unsuccessful stores in rightmost columns of the table, and wherein the rows of the table comprise the benchmarks clustered together based on degrees of correlation between the successful stores and the unsuccessful stores.

13. The method of claim 12, wherein maintaining the MLM further includes continuously training the MLM on updated benchmark values as input and actual KPI values as an expected output from the MLM.

14. The method of claim 11, wherein receiving further includes receiving the changed value as a percentage increase or a percentage decrease over the given benchmark value.

15. The method of claim 11, wherein receiving further includes receiving a second changed value for a second benchmark value from the user interface for the given store.

16. The method of claim 15, wherein providing further includes provide the second changed value, the changed value, and the other corresponding current benchmark values to the MLM as input and obtaining the set of predicted KPI values as output from the MLM.

17. The method of claim 11 further comprising using the current data model and the MLM and maintaining current scorecards for each of the stores, the current scorecards comprise a current set of predicted KPI values for each of the stores based on current benchmark values for the successful stores and the unsuccessful stores.

18. The method of claim 17 further comprising, presenting a scorecard view option or a dashboard option within the user interface that presents the current scorecards for each of the successful stores and each of the unsuccessful stores to an end user operating the user interface.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
maintaining a data structure that clusters benchmarks of the successful stores and unsuccessful stores based on degrees of correlation and benchmark values for the benchmarks;
maintaining a trained machine-learning model (MLM) that is trained on the clusters and benchmark values and actual Key Performance Indicator (KPI) values to predict KPI values from current benchmark values;
providing a user interface that permits an end user to provide an override value for a current benchmark value of a given store or of a given department of the given store;
providing the override value and other current benchmark values received from the user interface for the given store or for the given department to the MLM as input;
receiving current predicted KPI values for the given store or the given department as output from the MLM; and
rendering the current predicted KPI values based on the override value to the end user within the user interface.

20. The system of claim 19, wherein the executable instructions are accessible as a Software-as-a-Service (SaaS) to one or more of a retail server of the retailer and store servers of the stores.
